(19) United States
(12) Patent Application Publication
(10) Pub. No.: US 2020/0133910 A1
(43) Pub. Date: Apr. 30, 2020

(54) PROGRAMMED DELAY FOR RFFE BUS TRIGGERS

(71) Applicant: QUALCOMM Incorporated, San Diego, CA (US)

(72) Inventors: Reza RODD, San Diego, CA (US); Scott DAVENPORT, Merrimack, NH (US); Umesh SRIKANTIAH, San Diego, CA (US); ZhenQi CHEN, Shirley, MA (US)

(21) Appl. No.: 16/590,879

(22) Filed: Oct. 2, 2019

Related U.S. Application Data
(60) Provisional application No. 62/750,144, filed on Oct. 24, 2018.

(51) Int. Cl. G06F 13/42; H04L 12/16

(52) U.S. Cl. CPC G06F 13/4291; H04B 1/38; H04L 12/16

(57) ABSTRACT

Systems, methods, and apparatus for improving bus latency are described. A data communication apparatus has an interface circuit adapted to couple the apparatus to a first serial bus, a clock source configured to provide a clock signal and a trigger handler. The interface circuit may be configured to receive trigger configuration information in a first transaction conducted over a serial bus, and receive a trigger actuation command from a bus master coupled to the serial bus. The trigger handler may be configured to delay a trigger actuation signal for a delay duration defined by the trigger configuration information, and provide the trigger actuation signal after the delay duration has expired. The trigger actuation signal may be generated in response to the trigger actuation command.

### PRIORITY

This application claims priority to and the benefit of U.S. Provisional Patent Application Ser. No. 62/750,144 filed in the U.S. Patent Office on Oct. 24, 2018, the entire content of this application being incorporated herein by reference as if fully set forth below in its entirety and for all applicable purposes.

### TECHNICAL FIELD

The present disclosure relates generally to serial communication over a shared serial bus and, more particularly, to optimizing timing of time-critical triggers initiated by transmissions over the shared serial bus.

### BACKGROUND

Mobile communication devices may include a variety of components including circuit boards, integrated circuit (IC) devices and/or System-on-Chip (SoC) devices. The components may include processing circuits, user interface components, storage and other peripheral components that communicate through a serial bus. The serial bus may be operated in accordance with a standardized or proprietary protocol. In one example, a serial bus may be operated in accordance with an Inter-Integrated Circuit (I2C bus or I²C). The I2C bus was developed to connect low-speed peripherals to a processor, where the I2C bus is configured as a multi-drop bus. A two-wire I2C bus includes a Serial Data Line (SDA) that carries a data signal, and a Serial Clock Line (SCL) that carries a clock signal.

A serial bus may employ a multi-master protocol in which one or more devices can serve as a master and a slave for different messages transmitted on the serial bus. In one example, Improved Inter-Integrated Circuit (I3C) protocols may be used to control operations on a serial bus. I3C protocols are defined by the Mobile Industry Processor Interface (MIPI) Alliance and derive certain implementation aspects from the I2C protocol. Original implementations of the I2C protocol supported data signaling rates of up to 100 kilobits per second (100 kbps) in standard-mode operation, with more recent standards supporting speeds of 400 kbps in fast-mode operation, and 1 megabit per second (Mbps) in fast-mode plus operation.

In another example, the Radio Frequency Front-End (RFFE) interface defined by the MIPI Alliance provides a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communication device, multiple antennas and radio transceivers may be provided to support multiple concurrent RF links.

In another example, the system power management interface (SPMI) defined by the MIPI Alliance provides a hardware interface that may be implemented between baseband or application processors and peripheral components. In some implementations, the SPMI is deployed to support power management operations within a device.

In many instances, a multi-drop serial bus may be provided to support high-priority, low-latency communication between an application processor and certain peripherals, in addition to lower-priority communication. Latency can be adversely affected when multiple devices coupled to the serial bus are concurrently active and attempting to gain bus access for transmission initiation. Degraded latencies can lead to a failure to meet certain application performance limits. For example, degraded latency times can result in unreliable trigger timing, where an attempt by one device to trigger an action in another device at a precise time may be impeded due to degraded latencies. As mobile communication devices continue to include a greater level of functionality, improved serial communication techniques are needed to improve latencies and/or handling of priority traffic on a serial bus that couples peripherals and application processors.

### SUMMARY

Certain aspects of the disclosure relate to systems, apparatus, methods and techniques that can improve accuracy of triggers that are configured and/or initiated through transmissions over a serial bus, including when bus-latency is affected by congestion and other effects. Certain aspects disclosed herein can avoid trigger timing issues through the use of a delay mechanism initiated in response to trigger configuration information transmitted in advance of the desired trigger actuation time.

In various aspects of the disclosure, a data communication method performed at a device coupled to a serial bus includes receiving trigger configuration information in a first transaction conducted over a serial bus, receiving a trigger actuation command from a bus master coupled to the serial bus, delaying a trigger actuation signal for a delay duration defined by the trigger configuration information, and providing the trigger actuation signal after the delay duration has expired. The trigger actuation signal may be generated in response to the trigger actuation command. In one aspect, the method includes enabling a counter to count after receiving a trigger actuation command when a delay value register has been configured with a non-zero delay value by the bus master, and delaying the trigger actuation signal until the counter has a value that matches the non-zero delay value. The delay value register may be configured during the first transaction. The trigger actuation command may be received during the first transaction. In some examples, the method includes restarting the counter after providing the trigger actuation signal when the delay value register maintains the non-zero delay value, and providing an additional trigger actuation signal when the counter regains the value that matches the content of the delay value register again.

In one aspect, the method includes receiving a cancellation indicator in a second transaction conducted over the serial bus before providing the trigger actuation signal, and cancelling the trigger actuation signal in response to the cancellation indicator.

In one aspect, the trigger actuation command may be a broadcast command addressed to multiple devices coupled to the serial bus.

In various aspects of the disclosure, a data communication apparatus has an interface circuit adapted to couple the apparatus to a first serial bus, a clock source configured to provide a clock signal and a trigger handler. The interface circuit may be configured to receive trigger configuration information in a first transaction conducted over a serial bus, and receive a trigger actuation command from a bus master coupled to the serial bus. The trigger handler may be configured to delay a trigger actuation signal for a delay duration defined by the trigger configuration information, and provide the trigger actuation signal after the delay duration has expired. The trigger actuation signal may be generated in response to the trigger actuation command.

In various aspects of the disclosure, a data communication method performed at a device coupled to a serial bus includes transmitting trigger configuration information in a first transaction conducted over a serial bus, and transmitting a trigger actuation command to at least one slave device coupled to the serial bus. The trigger configuration information may define a delay duration used by the at least one slave device to delay one or more trigger actuation signals generated by the at least one slave device in response to the trigger actuation command.

In one aspect, the trigger actuation command is transmitted in the first transaction. In one aspect, the trigger actuation command is transmitted in a second transaction after the first transaction. In one aspect, the trigger configuration information causes the at least one slave device to repetitively transmit a trigger actuation signal at a frequency defined by the delay duration.

In some aspects, the method includes transmitting a cancellation indicator in a third transaction conducted over the serial bus. The cancellation indicator may be configured to cause the at least one slave device to cancel the trigger actuation signal in response. The trigger actuation command may be a broadcast command addressed to multiple slave devices coupled to the serial bus.

In various aspects of the disclosure, a data communication apparatus has an interface circuit adapted to couple the apparatus to a first serial bus, and a processor. The processor may be configured to transmit trigger configuration information in a first transaction conducted over a serial bus, and transmit a trigger actuation command to at least one slave device coupled to the serial bus. The trigger configuration information may define a delay duration used by the at least one slave device to delay one or more trigger actuation signals generated by the at least one slave device in response to the trigger actuation command.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates datagram structures defined by RFFE protocols.

FIG. 5 illustrates actuation of triggers in accordance with certain aspects disclosed herein.

FIG. 6 illustrates certain features of an RFFE peripheral that has been adapted to support delayed triggers in accordance with certain aspects disclosed herein.

FIG. 7 illustrates timing associated with a programmable delay implemented in accordance with certain aspects disclosed herein.

FIG. 8 illustrates an example of a counter-based programmable delay circuit operable in accordance with certain aspects disclosed herein.

FIG. 9 illustrates one example of an apparatus employing a processing circuit that may be adapted according to certain aspects disclosed herein.

FIG. 10 is a flowchart that illustrates a method that may be performed by a master device coupled to a serial bus in accordance with certain aspects disclosed herein.

FIG. 11 illustrates a first example of a hardware implementation for an apparatus adapted in accordance with certain aspects disclosed herein.

FIG. 12 is a flowchart that illustrates a method that may be performed by a slave device coupled to a serial bus in accordance with certain aspects disclosed herein.

FIG. 13 illustrates a second example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include application-specific IC (ASIC) devices, SoCs and/or other IC devices often employ a shared communication interface that may include a serial bus or other data communication link to connect processors with modems and other peripherals. The serial bus or other data communication link may be operated in accordance with multiple standards or protocols defined. For example, the serial bus may be operated in accordance with an I2C, I3C, SPMI, and/or RFFE protocol, or another protocol that may be configured for half-duplex operation. Increased utilization of serial buses, and/or the imposition of more stringent timing constraints in support of applications, peripherals and sensors can result in demand for reduced transmission latencies. Transmission latency may include the time required to terminate a transaction in process on the serial bus, bus turnaround (between transmit mode and receive mode), bus arbitration and/or command transmissions specified by protocol.

High bus latency can limit the capabilities and functionality of a serial bus in certain applications. For example, bus latency considerations may limit the number of radio frequency (RF) devices that can be coupled by an I3C, RFFE or SPMI bus. In some examples, multiple serial buses may be implemented to enable RF or other low-latency devices to communicate within tight time constraints, including where bus throughput, utilization and/or other operating characteristics are otherwise easily supported by a single bus.

Certain operations in a radio frequency IC (RFIC) require very low-latency communications. For example, configuration and reconfiguration of circuits used to drive multiple antennas may generate large volumes of messages, commands and signaling directed to multiple radio frequency components. In many instances, the messages may include configuration parameters that are to be applied at a time determined by a controlling device. In some instances, triggers may be sent to activate a configuration defined by previously provided configuration parameters. In one example, triggers may be sent to initiate or actuate a sequence of configurations or actions in a radio frequency device according to a defined timeline. Congestion and bus-latency can result in mistiming of triggers when the triggers are configured and/or initiated through transmissions over a serial bus.

Certain aspects disclosed herein can avoid timing issues arising from bus congestion by transmitting trigger configuration before the desired trigger actuation time, where the receiving device delays actuation of the triggers in accordance with delay information provided with the trigger configuration. In one example, a data communication method performed at a device coupled to a serial bus includes receiving trigger configuration information in a first transaction conducted over a serial bus, receiving a trigger actuation command from a bus master coupled to the serial bus, delaying a trigger actuation signal for a delay duration defined by the trigger configuration information, and providing the trigger actuation signal after the delay duration has expired. The trigger actuation signal may be generated in response to the trigger actuation command.

Certain aspects disclosed herein may be applicable to a serial bus operated in accordance with an I2C, I3C, SPMI, and/or RFFE protocol, or other protocol. Certain aspects are applicable to a serial bus operated in half-duplex mode or full-duplex mode. Certain aspects are applicable to point-to-point interfaces including UART-based interfaces, line multiplexed UART (LM-UART) interfaces, and virtual GPIO (VGI) and messaging interfaces. Certain aspects are applicable to multipoint interfaces and/or interfaces when operated in point-to-point mode.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

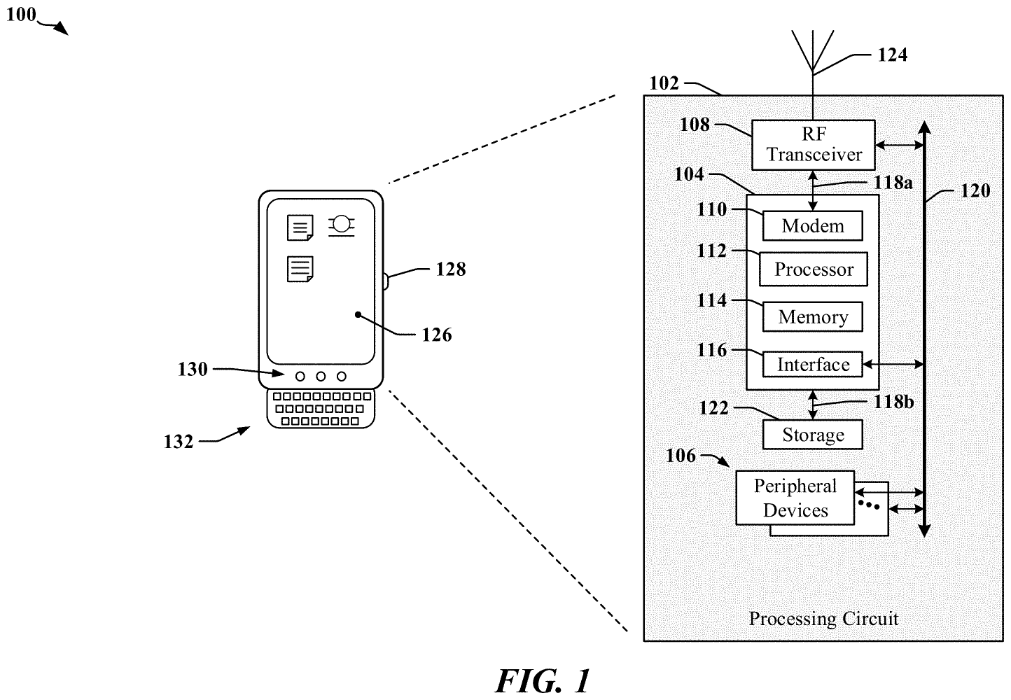

FIG. 1 illustrates an example of an apparatus 100 that employs a data communication bus. The apparatus 100 may include a processing circuit 102 that has multiple circuits or devices 104, 106 and/or 108, and which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or in the processor-readable storage 122. The ASIC 104 may access its on-board memory 114, the processor-readable storage 122, and/or storage external to the processing circuit 102. The on-board memory 114 and/or the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable communication between certain devices 104, 106, and/or 108. In one example, the ASIC 104 may include a bus interface circuit 116 that is implemented using a combination of circuits, counters, timers, control logic and other configurable circuits or modules. In one example, the bus interface circuit 116 may be configured to operate in accordance with standards-defined communication specifications or protocols. The processing circuit 102 may include or control a power management function that configures and manages the operation of the apparatus 100.

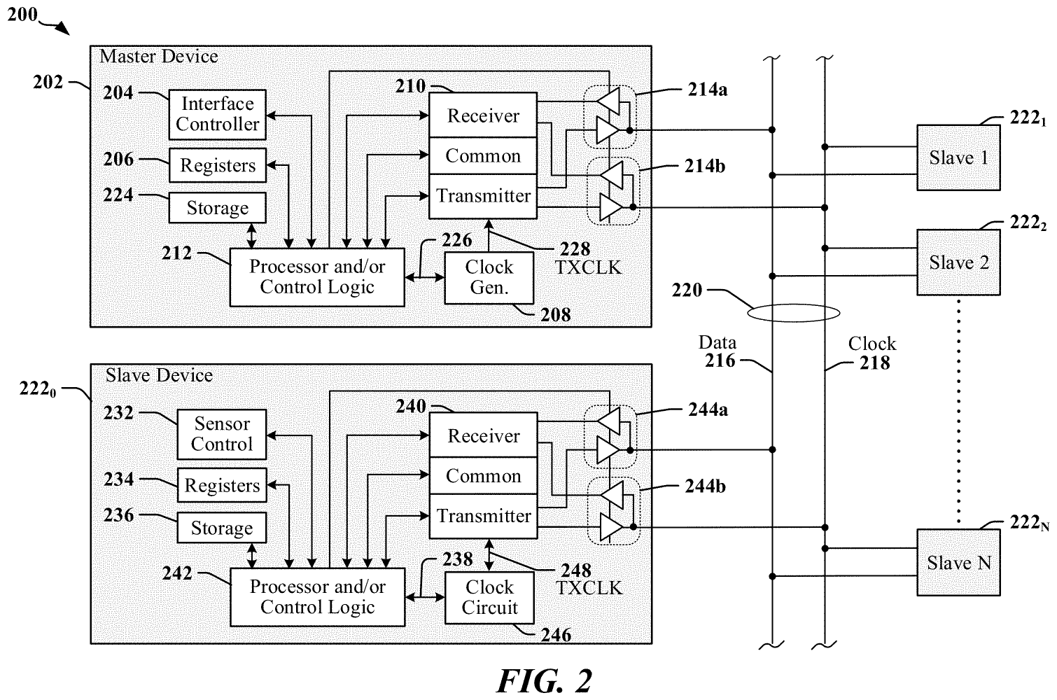

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an application processor, SoC or ASIC. In various implementations, the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master device 202. Certain types of bus can support multiple bus master devices 202.

In one example, a bus master device 202 may include an interface controller 204 that manages access to the serial bus, configures dynamic addresses for slave devices 222₀-222_{N} and/or generates a clock signal 228 to be transmitted on a clock line 218 of the serial bus 220. The bus master device 202 may include configuration registers 206 or other storage 224, and other control logic 212 configured to handle protocols and/or higher-level functions. The control logic 212 may include a processing circuit having a processing device such as a state machine, sequencer, signal processor or general-purpose processor. The bus master device 202 includes a transceiver 210 and line drivers/receivers 214a and 214b. The transceiver 210 may include receiver circuits, transmitter circuits and common circuits, where the common circuits may include timing, logic and storage circuits and/or devices. In one example, the transmitter circuits encode and transmit data based on timing in the clock signal 228 provided by a clock generation circuit 208. Other timing clock signals 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit that has a processing device such as a state machine, sequencer, signal processor or general-purpose processor. The transceiver 240 may include receiver circuits, transmitter circuits and common circuits, where the common circuits may include timing, logic and storage circuits and/or devices. In one example, the transmitter circuits encode and transmit data based on timing in a clock signal 248 provided by clock generation and/or recovery circuits 246. The clock signal 248 may be derived from a signal received from the clock line 218. Other timing clock signals 238 may be used by the control logic 242 and other functions, circuits or modules.

The serial bus 220 may be operated in accordance with RFFE, I2C, I3C, SPMI, or other protocol. In some instances, two or more devices 202, 222₀-222_{N} may be configured to operate as a bus master device on the serial bus 220. In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, data is transmitted on a data line 216 of the serial bus 220 based on timing information provided in a clock signal transmitted on the clock line 218 of the serial bus 220. In some instances, data may be encoded in the signaling state, or transitions in signaling state of both the data line 216 and the clock line 218.

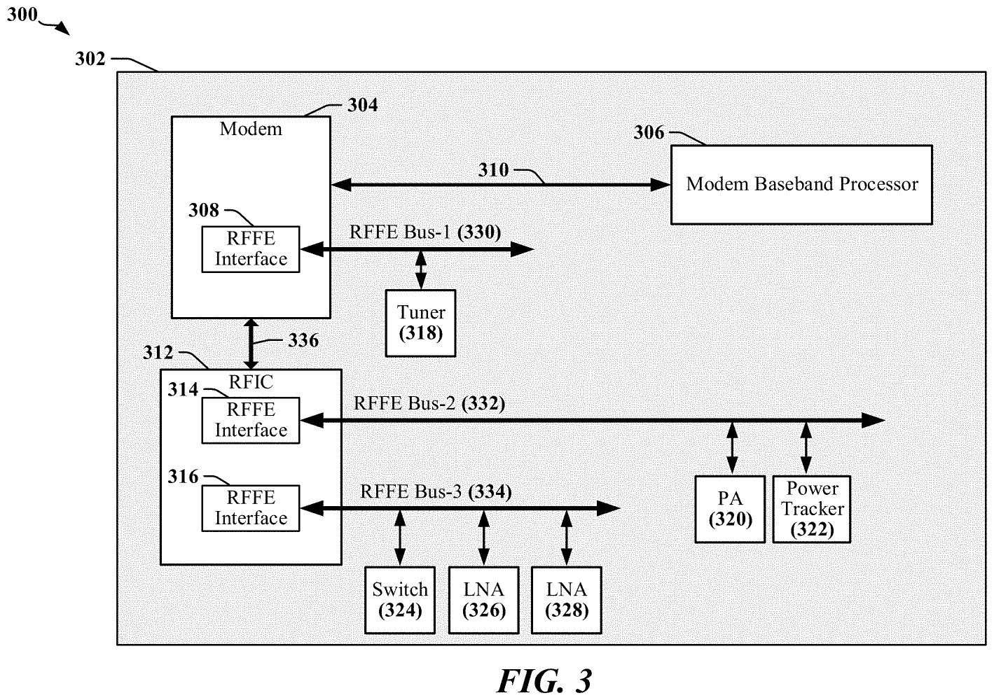

FIG. 3 illustrates certain aspects of an apparatus 300 that includes multiple RFFE buses 330, 332, 334 configured coupled to various RF front-end devices 318, 320, 322, 324, 326, 328. A modem 302 includes an RFFE interface 308 that couples the modem 302 to a first RFFE bus 330. The modem 302 may communicate with a baseband processor 306 and a Radio-Frequency IC (RFIC 312) through one or more communication links 310, 336. The illustrated apparatus 300 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the apparatus 300 may be implemented with one or more baseband processors 306, modems 304, RFICs 312, multiple communications links 310, 336, multiple RFFE buses 330, 332, 334 and/or other types of buses. The apparatus 300 may include other processors, circuits, modules and may be configured for various operations and/or for a variety of functionalities. In the example illustrated in FIG. 3, the modem 302 is coupled to an RF tuner 318 through its RFFE interface 308 and the first RFFE bus 330. The RFIC 312 may include one or more RFFE interfaces 314, 316, controllers, state machines and/or processors that can configure and control certain aspects of the RF front-end. The RFIC 312 may communicate with a PA 320 and a power tracking module 322 through a first of its RFFE interfaces 314 and the second RFFE bus 330. The RFIC 312 may communicate with a switch 324 and one or more LNAs 326, 328.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

In certain examples, latency-sensitive messages can include coexistence messages. Coexistence messages are transmitted in a multisystem platform to prevent or reduce instances of certain device types impinging on each other, including for example, switches 324, LNAs 326, 328, PAs 320 and other types of device that operate concurrently in a manner that can generate inter-device interference, or that could potentially cause damage to one or more active devices through high-power electromagnetic interference. Devices that may interfere with one another may exchange coexistence management (CxM) messages to permit each device to signal imminent actions that may result in interference or conflict. CxM messages may be used to manage operation of shared components including a switch 324, LNA 326, 328, PA 320 and/or an antenna.

Multi-drop interfaces such as interfaces governed by RFFE, SPMI, I3C, and similar protocols can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. The example of RFFE protocols may be employed to illustrate certain aspects disclosed herein. However, the concepts disclosed herein are applicable to other serial bus protocols and standards.

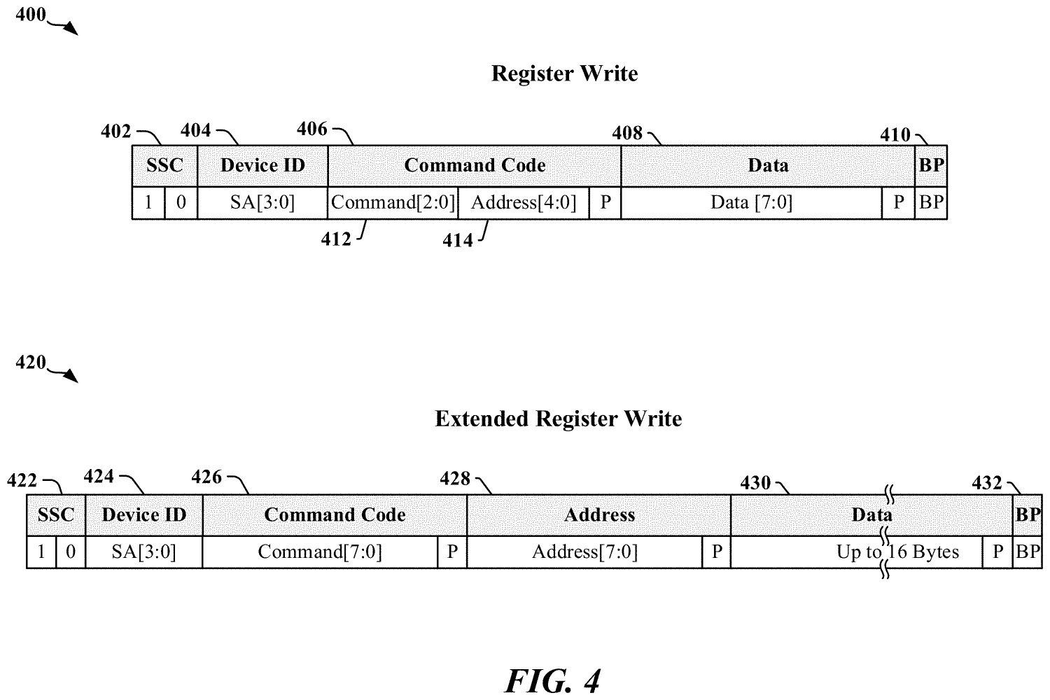

FIG. 4 illustrates datagram structures 400, 420 for a Register Write command and an Extended Register Write command. The datagram structures 400, 420 are consistent with structures defined by RFFE protocols, and can be used to efficiently write data to registers within the addressable register address range of a slave device. The datagram structures 400, 420 are also consistent with or similar to datagram structures defined by other protocols and may be adapted for use in accordance with certain aspects disclosed herein. The datagram structures 400, 420 commence with transmission of a two-bit sequence start condition (SSC 402, 422) followed by a four-bit device ID 404, 424. A nine-bit command field 406, 426 is transmitted next. In the Register Write command datagram structure 400, the nine-bit command field 406 includes a three-bit command code 412, a five-bit address field 414 and a parity bit. In the Extended Register Write command datagram structure 420, the nine-bit command field 406 is occupied by an eight-bit command code and a parity bit and followed by an address field 428 that carries an eight-bit register address and a parity bit. In the Register Write command datagram structure 400, a data field 408 carries a single data byte, while in the Extended Register Write command datagram structure 420 the data field 430 carries up to 16 data bytes. Each data byte is transmitted with a parity bit. Bus park signaling 410, 432 terminates the datagram structures 400, 420.

Triggers Transmitted Over a Multidrop Bus

Triggers provide a mechanism for RF front-end control, and triggers may be used to coordinate activities of different front-end components. For example, triggers can be used for a variety of purposes including beam steering or beamforming, gain setting, antenna path multiplexer control, etc. In some devices, triggers can be configured, activated and/or actuated over a serial bus operated in accordance with RFFE protocols. In a first example, a Bus Owner Master (BoM) may transmit a command that includes a trigger configuration and an action associated with the configured trigger, such that receipt of the command causes the trigger to be actuated or otherwise take effect or be applied. In the first example, the trigger configured by the command may be referred to as a self-actuating trigger. In a second example, the BoM transmits a first command that configures one or more triggers. The configuration may define an action associated with the configured triggers and may activate one or more triggers. The BoM may transmit a second command that actuates activated triggers.

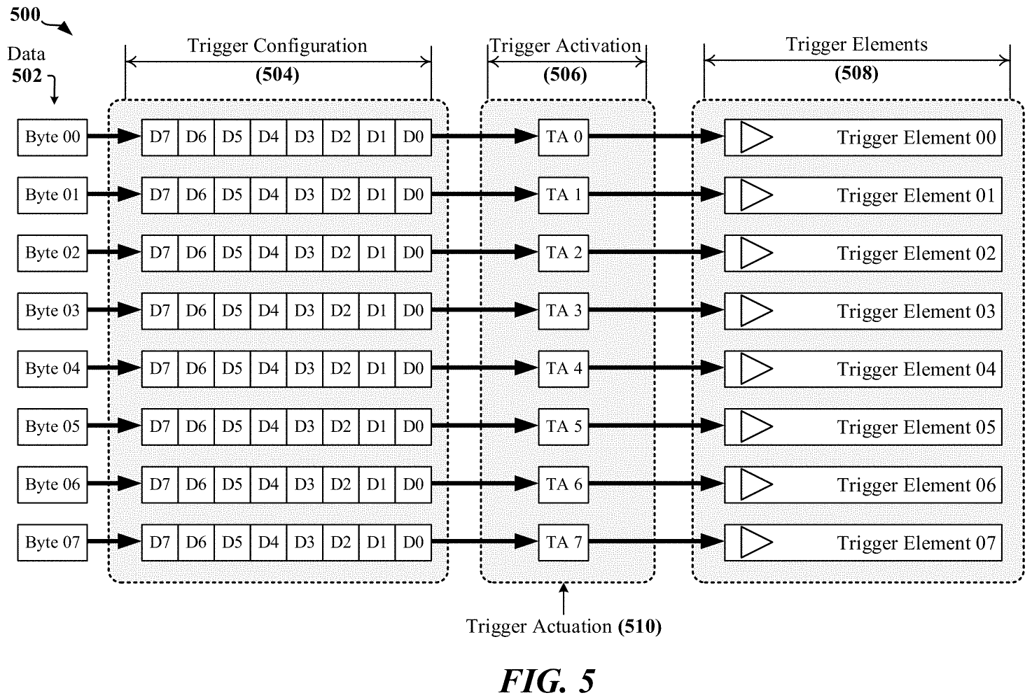

FIG. 5 illustrates a scheme 500 that illustrates actuation of activated triggers. In the illustrated example, configuration information is received as a plurality of data bytes 502, which may be stored in trigger configuration registers 504. The trigger configuration registers 504 may be written in a configuration transaction conducted over a serial bus, which may be operated in accordance with an RFFE protocol. The contents of the trigger configuration registers 504 may be forwarded to a target for configuration using a trigger activation procedure.

Trigger activation logic 506 may be configured to enable the contents of the trigger configuration registers 504 to be transferred to respective target devices in response to a trigger command or trigger actuation signal 510 received from a controlling device. In conventional systems, one or more trigger actuation commands may be transmitted to trigger the activation of configuration of at least a portion of targeted trigger elements 508. The trigger elements 508 may include switches 324, LNAs 326, 328, PAs 320 and other types of device that operate concurrently in an RF front-end. In one example, a trigger actuation transmission may configure a mask or gating logic that determines which trigger elements 508 are to receive data from the trigger configuration registers 504 during actuation initiated by the trigger actuation signal 510. In one example, the trigger actuation signal 510 is generated at the end of a datagram used to carry a trigger actuation command, which may be provided in accordance with a datagram structure 400, 420 illustrated in FIG. 4 for the Register Write command or the Extended Register Write command.

Advances in RF technology and the introduction of increased capabilities in communication devices increase pressure on latency times. For example, the deployment of radio access technologies such as the 5G New Radio technology defined by the 3rd Generation Partnership Project (3GPP) and the 802.11ax WLAN standard defined by the Institute of Electrical and Electronics Engineers (IEEE) 802.11 Working Group can require a 50% reduction in latency at conventional bus clock frequencies, increase complexity of RFFE bus architectures and increase the potential for traffic congestion on the bus. RFFE bus congestion and timing bottlenecks may be expected to exacerbate coexistence issues. For example, increased bus activity may increase bus contention issues where RFFE bus timing is complicated. In these scenarios, a BoM may be prevented from sending the triggers at an exact time needed by slave devices to meet the RF protocol timing.

Certain aspects disclosed herein provide mechanisms that enable a BoM to configure triggers with delayed actuation. The triggers can be configured before the time defined for actuation, and a slave device may wait for a defined period of time before actuating the trigger. In one example, the BoM can send triggers ahead of time and when bus traffic conditions allow. A slave device may include a configurable delay element that can be programmed such that slave device holds the trigger until actuation is enabled by the programmed delay duration.

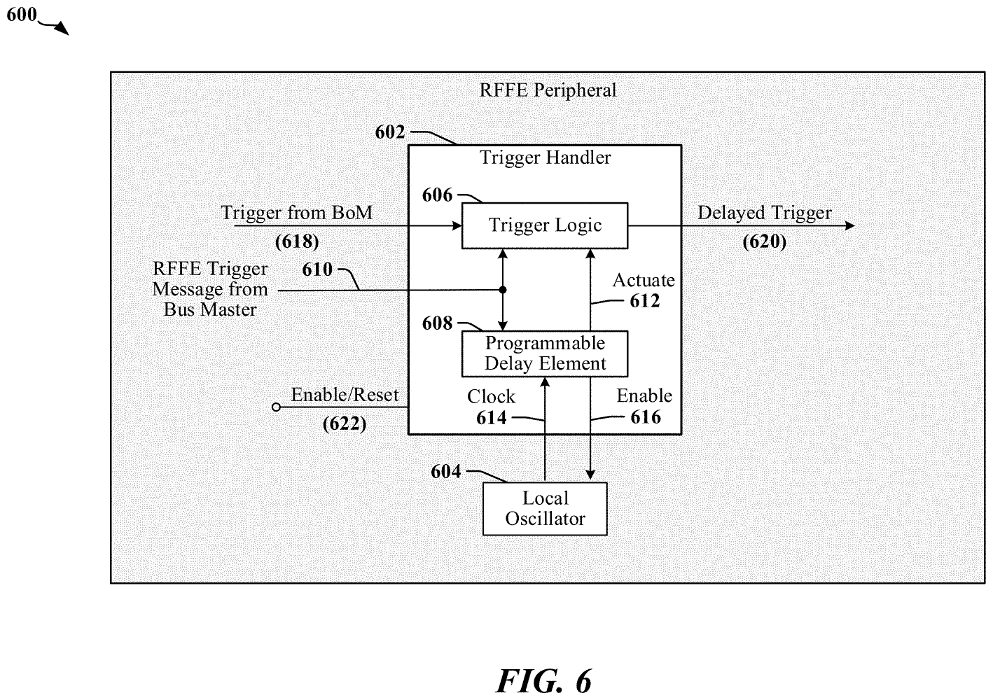

FIG. 6 illustrates certain features of an RFFE peripheral 600 that has been adapted to support delayed triggers in accordance with certain aspects disclosed herein. For the purposes of description, it can be assumed that trigger configuration and actuation information is communicated to the RFFE peripheral 600 by a BoM in one or more commands. A trigger handler 602 may receive configuration information 610 related to a trigger to be actuated after a programmed delay. The configuration information 610 may include delay information used to program a delay element 608. The configuration information 610 may include trigger information that selects one or more triggers to be actuated after the programmed delay. The configuration information 610 may specify an action to be taken in association with one or more triggers.

In one example, the configuration information 610 transmitted in a single command includes the delay information, the trigger information and specified actions to be taken. In another example, the delay information, the trigger information and/or information specifying actions may be transmitted in two or more commands or transactions conducted over the serial bus. For example, the actions associated with a trigger may be defined during device configuration by an application or during device initialization, while trigger activation and actuation may be initiated in one or more other commands.

The BoM may send a delayed actuation command that causes the delay element 608 to be initialized with a delay value. The delay element 608 may initiate a timer or counter and, in some instances, may provide an enable signal 616 that enables a clock generator 604 that produces a clock signal 614 used to measure the programmed delay. In some instances, the clock signal may be gated using the enable signal 616. In some instances, a counter or timer used to implement the delay element 608 may be controlled by the enable signal 616. The duration of the delay may be configured by the BoM during device initialization and/or indicated in the configuration information 610.

Trigger logic 606 may provide a delayed trigger 620 in response to an actuation signal 612 provided by the delay element 608 after the programmed delay. The trigger logic 606 may be configured to select one of multiple supported triggers, and may initiate an action configured for a selected trigger. In some instances, the trigger handler 602 may receive and delay a trigger 618 to provide the delayed trigger 620. In these instances, the trigger 618 may be received from a trigger signal generation circuit. In other instances, the delayed trigger 620 is generated by the trigger logic based on information provided in a bus transaction, and without receiving a dedicated signal carrying the trigger 618. In some implementations, the trigger handler 602 may be enabled, disabled, and/or reset through a signal 622 provided by the RFFE peripheral 600. The trigger handler 602 may be enabled, disabled, and/or reset by a bit-setting in one or more registers.

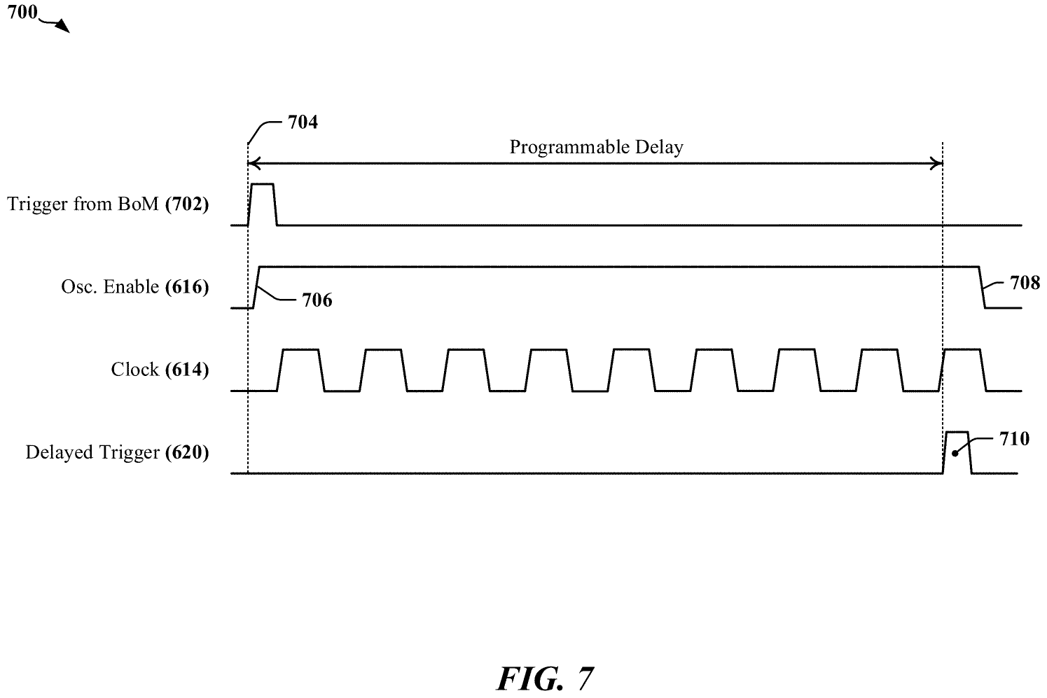

FIG. 7 illustrates timing associated with a programmable delay 700 implemented in accordance with certain aspects disclosed herein. A trigger 702 initiated by the BoM is received by the trigger handler 602 of the RFFE peripheral 600. The trigger 702 may be provided in a dedicated signal and/or may be generated in response to a command and/or configuration information 610. Upon detection of the trigger 702 at a start time 704, the enable signal 616 transitions high 706 to provide the clock signal 614 to the delay element 608. The delay element 608 counts a programmed number of pulses in the clock signal 614 before producing a trigger pulse 710 to serve as the delayed trigger 620. The enable signal 616 transitions low 708 to disable the clock signal 614.

FIGS. 6 and 7 illustrate certain examples of implementations that can provide accurate control over timing of trigger actuations in an RFFE slave device. During configuration, the BoM may program an expected trigger delay in the RFFE slave to enable the delayed trigger option. Upon receipt of a trigger by the RFFE slave, the trigger delay logic initiates a counter or timer and releases the trigger pulse 710 after an elapsed time determined by the counter or timer.

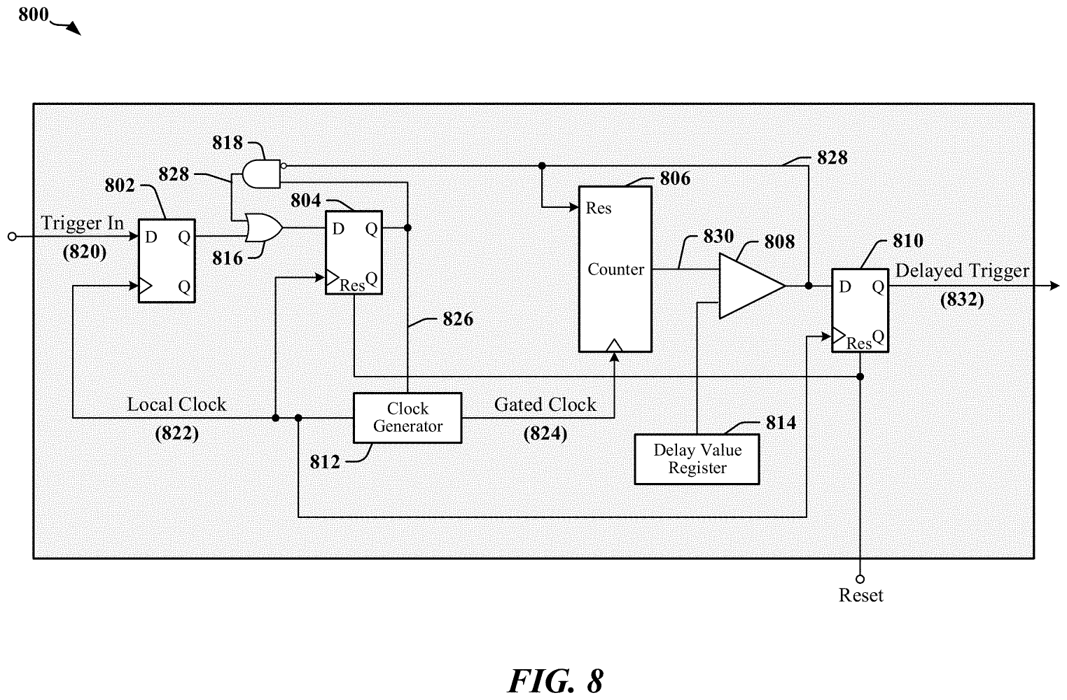

FIG. 8 illustrates an example of a counter-based programmable delay element 800 that operates in accordance with certain aspects disclosed herein. In this example, a trigger 820 is received at a first flipflop 802 that is clocked by a clock signal 822 generated by a local oscillator or other clock generator circuit 812 on the peripheral. In other examples, the clock signal 822 may be derived from a communication clock signal transmitted over the serial bus. In one example, the communication clock signal may be provided to a clock generator circuit 812 configured to produce the clock signal 822. The clock generator circuit 812 may include a phase-locked loop, for example.

The output of the first flipflop 802 is provided to a second flipflop 804 that is clocked by the clock signal 822. The output of the first flipflop 802 may be gated by an enable signal 828 through logic devices (the OR gate 816 and the AND gate 818), where the enable signal 828 follows the output 826 of the second flipflop 804 when the delayed trigger option is enabled. In one example, the delayed trigger option is enabled when the BoM has configured a delay value register 814 with a non-zero value. The content of the delay value register 814 is compared to the output 830 of a counter 806 using a digital comparator circuit 808, where the output 830 of the counter 806 is zero when no trigger is being processed. When the delay value register 814 is configured with a non-zero value before a trigger 820 is received, the digital comparator circuit 808 enables the AND gate 818 which gates the output 826 of the second flipflop 804. The second flipflop 804 operates to latch the trigger 820. The output 826 of the second flipflop 804 may be provided to the clock generator circuit 812 as an enable signal that enables a gated clock signal 824 to be provided to the counter 806. The counter 806 counts pulses in the gated clock signal 824 until the output 830 of the counter 806 matches the value stored in the delay value register 814. A match causes the digital comparator circuit 808 to drive the enable signal 828 high, clearing the second flipflop 804 and counter 806 at the next active clock edge. A third flipflop 810 is clocked by the clock signal 822 and is configured to latch the state of the enable signal 828. The output of the third flipflop 810 provides a delayed trigger pulse 832 that has a duration of one cycle of the clock signal 822.

In some implementations, the delay value register 814 is cleared after the delayed trigger pulse 832 has been provided. In these implementations, a one-time delayed trigger option is provided, and the BoM determines when the delayed trigger option is needed and the duration of the programmable delay 700. The duration of the programmable delay 700 may be determined as the bus master is transmitting the trigger configuration and/or actuation to a peripheral device. In some instances, the BoM may have already calibrated the peripheral device and may know the frequency of the clock signal 822.

In some implementations, the BoM expresses a desired delay duration in a time value or in terms of a number of cycles of a reference clock, where the peripheral device converts the desired delay duration to a corresponding number of cycles of the clock signal 822. In some of these implementations, the BoM may broadcast a trigger actuation command to multiple peripheral devices in order to cause triggers in each device to be simultaneously actuated. Each peripheral device converts the time value provided by the broadcast actuation command to a corresponding number of cycles of its internal clock signal 822. In some instances, the BoM may cause simultaneous actuation by programming a delay in each peripheral device individually and, in these instances, the programmed delay may be expressed in cycles of a calibrated clock signal 822.

In some implementations, the BoM may configure a delay value register 814 in a peripheral device with a persistent delay value. In one example, the use of a persistent delay value may be employed when one or more triggers are to be actuated in a sequence spaced by a fixed time interval. In another example, a persistent delay value may be employed to configure a periodic trigger, where the same trigger is to be actuated at fixed intervals over a prolonged period of time, where the frequency of the triggers is defined by the configured delay value.

In some implementations, the BoM may abort, terminate or otherwise cancel one or more triggers initiated using the delayed trigger option, before actuation occurs. A trigger may be cancelled when a high-priority activity preempts the action to be caused by the trigger. A periodic trigger may be cancelled. In one example, the BoM may cancel a periodic or repeating trigger by clearing the delay value register 814 when no trigger is pending. In another example, the BoM may transmit a command that causes the receiving peripheral device to reset logic that implements the delayed trigger option. In the example illustrated in FIG. 6, the RFFE peripheral 600 may respond to a delayed trigger option cancel command by asserting reset in a signal 622 provided to the trigger handler 602.

Examples of Processing Circuits and Methods

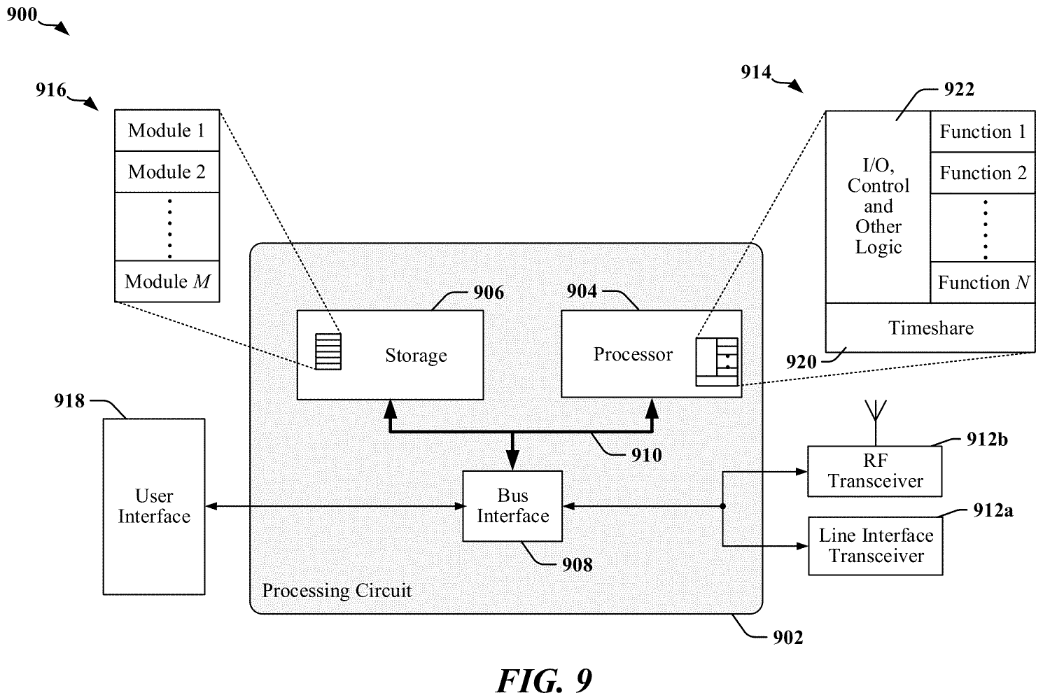

FIG. 9 is a diagram illustrating an example of a hardware implementation for an apparatus 900. In some examples, the apparatus 900 may perform one or more functions disclosed herein. In accordance with various aspects of the disclosure, an element, or any portion of an element, or any combination of elements as disclosed herein may be implemented using a processing circuit 902. The processing circuit 902 may include one or more processors 904 that are controlled by some combination of hardware and software modules. Examples of processors 904 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 904 may include specialized processors that perform specific functions, and that may be configured, augmented or controlled by one of the software modules 916. The one or more processors 904 may be configured through a combination of software modules 916 loaded during initialization, and further configured by loading or unloading one or more software modules 916 during operation.

In the illustrated example, the processing circuit 902 may be implemented with a bus architecture, represented generally by the bus 910. The bus 910 may include any number of interconnecting buses and bridges depending on the specific application of the processing circuit 902 and the overall design constraints. The bus 910 links together various circuits including the one or more processors 904, and storage 906. Storage 906 may include memory devices and mass storage devices, and may be referred to herein as computer-readable media and/or processor-readable media. The bus 910 may also link various other circuits such as timing sources, timers, peripherals, voltage regulators, and power management circuits. A bus interface 908 may provide an interface between the bus 910 and one or more transceivers 912a, 912b. A transceiver 912a, 912b may be provided for each networking technology supported by the processing circuit 902. In some instances, multiple networking technologies may share some or all of the circuitry or processing modules found in a transceiver 912a, 912b. Each transceiver 912a, 912b provides a means for communicating with various other apparatus over a transmission medium. In one example, a transceiver 912a may be used to couple the apparatus 900 to a multi-wire bus. In another example, a transceiver 912b may be used to connect the apparatus 900 to a radio access network. Depending upon the nature of the apparatus 900, a user interface 918 (e.g., keypad, display, speaker, microphone, joystick) may also be provided, and may be communicatively coupled to the bus 910 directly or through the bus interface 908.

A processor 904 may be responsible for managing the bus 910 and for general processing that may include the execution of software stored in a computer-readable medium that may include the storage 906. In this respect, the processing circuit 902 may be used to implement any of the methods, functions and techniques disclosed herein. The storage 906 may be used for storing data that is manipulated by the processor 904 when executing software, and the software may be configured to implement any one of the methods disclosed herein.

One or more processors 904 in the processing circuit 902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 906 or in an external computer-readable medium. The external computer-readable medium and/or storage 906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 906 may also include, by way of example, a carrier wave, a transmission line, and any other suitable medium for transmitting software and/or instructions that may be accessed and read by a computer. Computer-readable media and/or the storage 906 may reside in the processing circuit 902, in the processor 904, external to the processing circuit 902, or be distributed across multiple entities including the processing circuit 902. The computer-readable medium and/or storage 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 906 may maintain software maintained and/or organized in loadable code segments, modules, applications, programs, etc., which may be referred to herein as software modules 916. Each of the software modules 916 may include instructions and data that, when installed or loaded on the processing circuit 902 and executed by the one or more processors 904, contribute to a run-time image 914 that controls the operation of the one or more processors 904. When executed, certain instructions may cause the processing circuit 902 to perform functions in accordance with certain methods, algorithms and processes described herein.

Some of the software modules 916 may be loaded during initialization of the processing circuit 902, and these software modules 916 may configure the processing circuit 902 to enable performance of the various functions disclosed herein. For example, some software modules 916 may configure internal devices and/or logic circuits 922 of the processor 904, and may manage access to external devices such as a transceiver 912a, 912b, the bus interface 908, the user interface 918, timers, mathematical coprocessors, and so on. The software modules 916 may include a control program and/or an operating system that interacts with interrupt handlers and device drivers, and that controls access to various resources provided by the processing circuit 902. The resources may include memory, processing time, access to a transceiver 912a, 912b, the user interface 918, and so on.

One or more processors 904 of the processing circuit 902 may be multifunctional, whereby some of the software modules 916 are loaded and configured to perform different functions or different instances of the same function. The one or more processors 904 may additionally be adapted to manage background tasks initiated in response to inputs from the user interface 918, the transceiver 912a, 912b, and device drivers, for example. To support the performance of multiple functions, the one or more processors 904 may be configured to provide a multitasking environment, whereby each of a plurality of functions is implemented as a set of tasks serviced by the one or more processors 904 as needed or desired. In one example, the multitasking environment may be implemented using a timesharing program 920 that passes control of a processor 904 between different tasks, whereby each task returns control of the one or more processors 904 to the timesharing program 920 upon completion of any outstanding operations and/or in response to an input such as an interrupt. When a task has control of the one or more processors 904, the processing circuit 902 is effectively specialized for the purposes addressed by the function associated with the controlling task. The timesharing program 920 may include an operating system, a main loop that transfers control on a round-robin basis, a function that allocates control of the one or more processors 904 in accordance with a prioritization of the functions, and/or an interrupt driven main loop that responds to external events by providing control of the one or more processors 904 to a handling function.

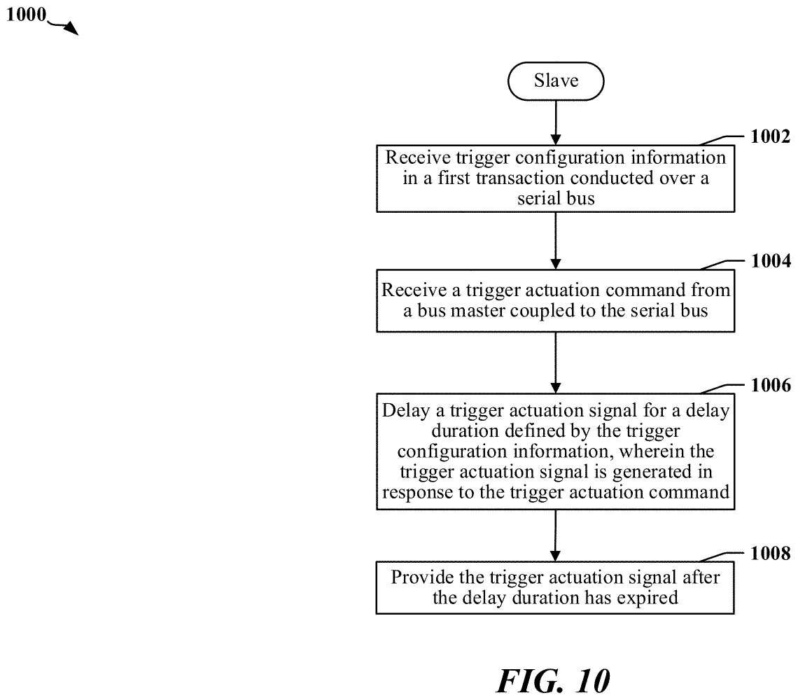

FIG. 10 is a flowchart 1000 of a method that may be performed by a device coupled to a serial bus. In one example, the serial bus may be operated in accordance with an RFFE protocol. At block 1002, the device may receive trigger configuration information in a first transaction conducted over a serial bus. At block 1004, the device may receive a trigger actuation command from a bus master coupled to the serial bus. At block 1006, the device may delay a trigger actuation signal for a delay duration defined by the trigger configuration information. The trigger actuation signal may be generated in response to the trigger actuation command. At block 1008, the device may provide the trigger actuation signal after the delay duration has expired.

In certain examples, the device may enable a counter to count after receiving a trigger actuation command when a delay value register has been configured with a non-zero delay value by the bus master, and delay the trigger actuation signal until the counter has a value that matches the non-zero delay value. In other examples, the delay value may be loaded into a down-counting counter and the trigger actuation signal may be delayed until the counter reaches zero. The trigger actuation signal may initiate one or more actions, such as disabling or enabling a circuit, loading a configuration register and/or activating a switch. The delay value register may be configured during the first transaction. The trigger actuation command may be received during the first transaction. In some instances, the device may restart the counter after providing the trigger actuation signal when the delay value register maintains the non-zero delay value, and may provide an additional trigger actuation signal when the counter regains the value that matches the content of the delay value register again. The trigger actuation command may be a broadcast command addressed to multiple devices coupled to the serial bus.

In some examples, the device may receive a cancellation indicator in a second transaction conducted over the serial bus before providing the trigger actuation signal, and may cancel the trigger actuation signal in response to the cancellation indicator. In one example, the cancellation indicator may be provided in a command. In another example, the cancellation indicator may relate to a group address. In another example, the cancellation indicator may be generated internally, by an application, RFFE device or by communication protocol handler.

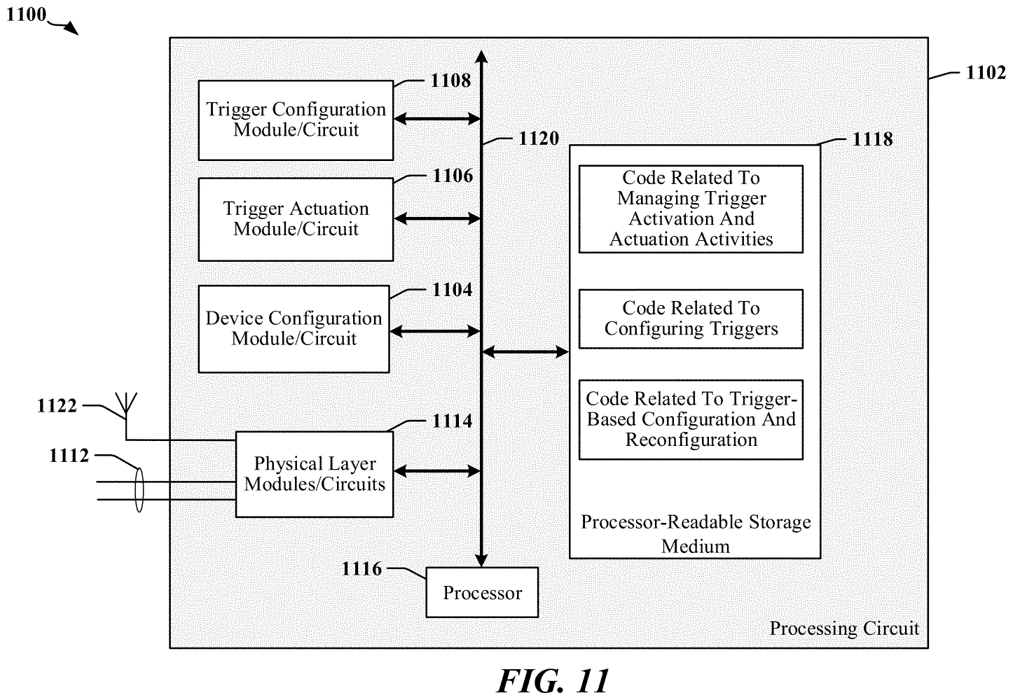

FIG. 11 is a diagram illustrating a simplified example of a hardware implementation for an apparatus 1100 employing a processing circuit 1102. The processing circuit 1102 typically has a controller or processor 1116 that may include one or more microprocessors, microcontrollers, digital signal processors, sequencers and/or state machines. The processing circuit 1102 may be implemented with a bus architecture, represented generally by the bus 1120. The bus 1120 may include any number of interconnecting buses and bridges depending on the specific application of the processing circuit 1102 and the overall design constraints. The bus 1120 links together various circuits including one or more processors and/or hardware modules, represented by the controller or processor 1116, the modules or circuits 1104, 1106 and 1108 and the processor-readable storage medium 1118. One or more physical layer circuits and/or modules 1114 may be provided to support communications over a communication link implemented using a serial bus 1112, through an antenna or antenna array 1122 (to a radio access network for example), and so on. The bus 1120 may also link various other circuits such as timing sources, peripherals, voltage regulators, and power management circuits, which are well known in the art, and therefore, will not be described any further.

The processor 1116 is responsible for general processing, including the execution of software, code and/or instructions stored on the processor-readable storage medium 1118. The processor-readable storage medium 1118 may be implemented using a non-transitory storage medium. The software, when executed by the processor 1116, causes the processing circuit 1102 to perform the various functions described supra for any particular apparatus. The processor-readable storage medium 1118 may be used for storing data that is manipulated by the processor 1116 when executing software. The processing circuit 1102 further includes at least one of the modules 1104, 1106 and 1108. The modules 1104, 1106 and 1108 may be software modules running in the processor 1116, resident/stored in the processor-readable storage medium 1118, one or more hardware modules coupled to the processor 1116, or some combination thereof. The modules 1104, 1106 and 1108 may include microcontroller instructions, state machine configuration parameters, or some combination thereof.

In one configuration, the apparatus 1100 includes modules and/or circuits 1108 adapted to maintain configuration information relating trigger actuation commands to triggers and configuration information for implementing delays when the delayed trigger option is used. The apparatus 1100 may include modules and/or circuits 1106 adapted to generate trigger activation signals in response to trigger actuation commands. The apparatus 1100 may include modules and/or circuits 1104 adapted to configure, conduct and/or participate in a transaction over the serial bus that includes exchanging configuration information.

In one example, the apparatus 1100 includes physical layer circuits and/or modules 1114 that implement an interface circuit adapted to couple the apparatus 1100 to a serial bus 1112, including a first serial bus. The apparatus 1100 may have a trigger handler implemented using logic circuits and/or the processor 1116. The interface circuit may be configured to receive trigger configuration information in a first transaction conducted over a serial bus, and receive a trigger actuation command from a bus master coupled to the serial bus. In some instances, the trigger configuration information may be received with the trigger actuation command. The apparatus 1100 may include a clock source configured to provide an internal clock signal. The trigger handler may be configured to delay a trigger actuation signal for a delay duration defined by the trigger configuration information. The trigger actuation signal may be generated in response to the trigger actuation command. The trigger handler may be configured to provide the trigger actuation signal after the delay duration has expired.

In some examples, the trigger handler may have a counter configured to count clock pulses in the clock signal and a delay value register. The trigger handler may be configured to enable the counter to count after receiving a trigger actuation command when the delay value register has been configured with a non-zero delay value by the bus master, and delay the trigger actuation signal until the counter has a value that matches the non-zero delay value. The delay value register may be configured during the first transaction. The trigger actuation command may be received during the first transaction. The trigger actuation command may be a broadcast command addressed to multiple devices coupled to the serial bus.

In one example, the trigger handler is configured to restart the counter after providing the trigger actuation signal when the delay value register maintains the non-zero delay value, and provide an additional trigger actuation signal when the counter regains the value that matches the content of the delay value register again.

In some instances, the interface circuit may receive a cancellation indicator in a second transaction conducted over the serial bus before providing the trigger actuation signal. The trigger handler may be further configured to cancel the trigger actuation signal in response to the cancellation indicator.

The processor-readable storage medium 1118 may include instructions that cause the processing circuit 1102 to receive trigger configuration information in a first transaction conducted over a serial bus, receive a trigger actuation command from a bus master coupled to the serial bus, delay a trigger actuation signal for a delay duration defined by the trigger configuration information, and provide the trigger actuation signal after the delay duration has expired. The trigger actuation signal may be generated in response to the trigger actuation command.

The processor-readable storage medium 1118 may include further instructions that cause the processing circuit 1102 to enable a counter to count after receiving a trigger actuation command when a delay value register has been configured with a non-zero delay value by the bus master, and delay the trigger actuation signal until the counter has a value that matches the non-zero delay value. The delay value register may be configured during the first transaction. The trigger actuation command may be received during the first transaction. The processor-readable storage medium 1118 may include instructions that cause the processing circuit 1102 to restart the counter after providing the trigger actuation signal when the delay value register maintains the non-zero delay value, and to provide an additional trigger actuation signal when the counter regains the value that matches the non-zero delay value.

The processor-readable storage medium 1118 may include instructions that cause the processing circuit 1102 to receive a cancellation indicator in a second transaction conducted over the serial bus before providing the trigger actuation signal, and cancel the trigger actuation signal in response to the cancellation indicator. The trigger actuation command may be a broadcast command addressed to multiple devices coupled to the serial bus.

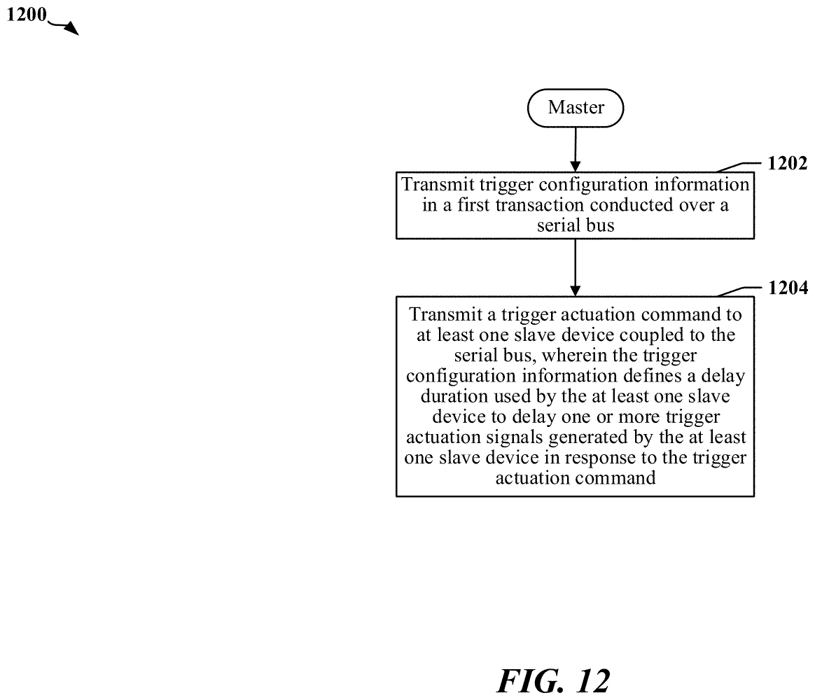

FIG. 12 is a flowchart 1200 of a method that may be performed by a master device coupled to a serial bus. In one example, the serial bus may be operated in accordance with an RFFE protocol. At block 1202, the master device may transmit trigger configuration information in a first transaction conducted over a serial bus. At block 1204, the master device transmits a trigger actuation command to at least one slave device coupled to the serial bus. The trigger configuration information may define a delay duration used by the at least one slave device to delay one or more trigger actuation signals generated by the at least one slave device in response to the trigger actuation command.

In one example, the trigger actuation command is transmitted in the first transaction. In another example, the trigger actuation command is transmitted in a second transaction after the first transaction. The trigger actuation command is a broadcast command addressed to multiple slave devices coupled to the serial bus. In some instances, the trigger configuration information causes the at least one slave device to repetitively transmit a trigger actuation signal at a frequency defined by the delay duration. In certain implementations, the master device may transmit a cancellation indicator in a third transaction conducted over the serial bus. The cancellation indicator is configured to cause the at least one slave device to cancel the trigger actuation signal in response. The cancellation indicator may be configured to cause the at least one slave device to cancel the trigger actuation signal in response.

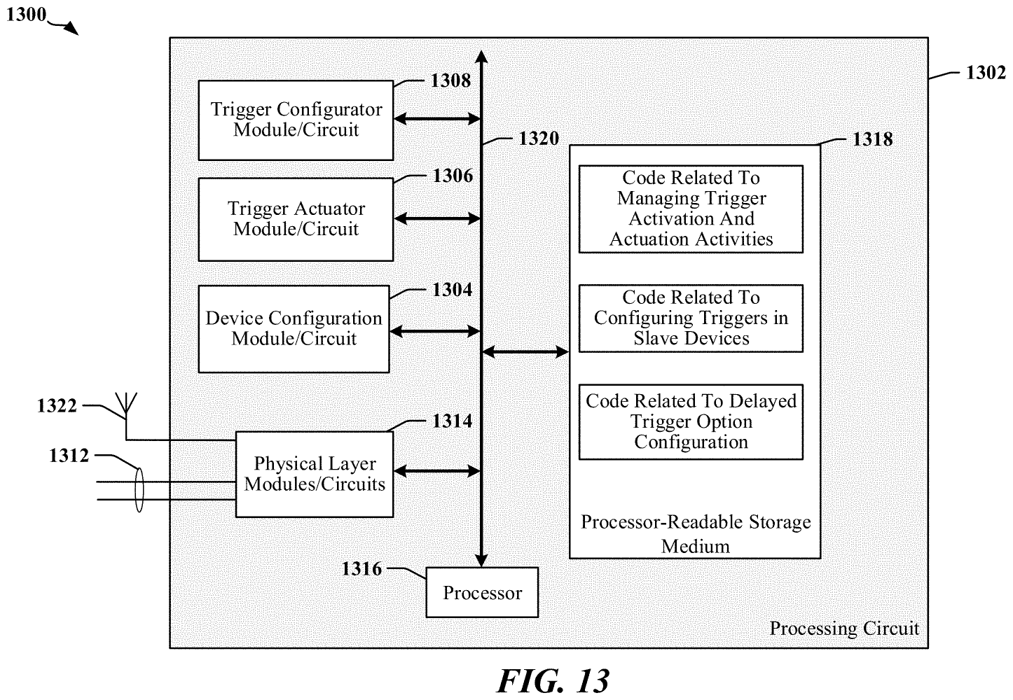

FIG. 13 is a diagram illustrating a simplified example of a hardware implementation for an apparatus 1300 employing a processing circuit 1302. The processing circuit 1302 typically has a controller or processor 1316 that may include one or more microprocessors, microcontrollers, digital signal processors, sequencers and/or state machines. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the controller or processor 1316, the modules or circuits 1304, 1306 and 1308 and the processor-readable storage medium 1318. One or more physical layer circuits and/or modules 1314 may be provided to support communications over a communication link implemented using a serial bus 1312, through an antenna or antenna array 1322 (to a radio access network for example), and so on. The bus 1320 may also link various other circuits such as timing sources, peripherals, voltage regulators, and power management circuits, which are well known in the art, and therefore, will not be described any further.

The processor 1316 is responsible for general processing, including the execution of software, code and/or instructions stored on the processor-readable storage medium 1318. The processor-readable storage medium 1318 may be implemented using a non-transitory storage medium. The software, when executed by the processor 1316, causes the processing circuit 1302 to perform the various functions described supra for any particular apparatus. The processor-readable storage medium 1318 may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the processor-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1100 includes modules and/or circuits 1108 adapted to configure trigger information in one or more slave devices, including configuration information relating trigger actuation commands to triggers and delay values used when the delayed trigger option is used. The apparatus 1100 may include modules and/or circuits 1106 adapted to generate trigger activation commands and timing associated with the delayed trigger option. The apparatus 1100 may include modules and/or circuits 1104 adapted to configure, conduct and/or participate in a transaction over the serial bus that includes exchanging configuration information.

In one example, the apparatus 1300 includes physical layer circuits and/or modules 1314 that implement an interface circuit adapted to couple the apparatus 1300 to a serial bus 1312, including a first serial bus. The apparatus 1300 may have a processor configured to transmit trigger configuration information in a first transaction conducted over a serial bus, transmit a trigger actuation command to at least one slave device coupled to the serial bus. The trigger configuration information may define a delay duration used by the at least one slave device to delay one or more trigger actuation signals generated by the at least one slave device in response to the trigger actuation command.

In one example, the trigger actuation command is transmitted in the first transaction. In another example, the trigger actuation command is transmitted in a second transaction after the first transaction. The trigger configuration information may cause the at least one slave device to repetitively transmit a trigger actuation signal at a frequency defined by the delay duration.

In some examples, the processor is further configured to transmit a cancellation indicator in a third transaction conducted over the serial bus. The cancellation indicator is configured to cause the at least one slave device to cancel the trigger actuation signal in response. The trigger actuation command may be a broadcast command addressed to multiple slave devices coupled to the serial bus.

The processor-readable storage medium 1318 may include instructions that cause the processing circuit 1302 to transmit trigger configuration information in a first transaction conducted over a serial bus, and transmit a trigger actuation command to at least one slave device coupled to the serial bus. The trigger configuration information may define a delay duration used by the at least one slave device to delay one or more trigger actuation signals generated by the at least one slave device in response to the trigger actuation command.

In some instances, the trigger actuation command is transmitted in the first transaction. In other instances, the trigger actuation command is transmitted in a second transaction after the first transaction. The trigger configuration information may cause the at least one slave device to repetitively transmit a trigger actuation signal at a frequency defined by the delay duration.

The processor-readable storage medium 1318 may include further instructions that cause the processing circuit 1302 to transmit a cancellation indicator in a third transaction conducted over the serial bus. The cancellation indicator may be configured to cause the at least one slave device to cancel the one or more trigger actuation signals. The trigger actuation command may include a broadcast command addressed to multiple slave devices coupled to the serial bus.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of data communications, comprising:
receiving trigger configuration information in a first transaction conducted over a serial bus;
receiving a trigger actuation command from a bus master coupled to the serial bus;
delaying a trigger actuation signal for a delay duration defined by the trigger configuration information, wherein the trigger actuation signal is generated in response to the trigger actuation command; and
providing the trigger actuation signal after the delay duration has expired.

2. The method of claim 1, further comprising:
enabling a counter to count after receiving the trigger actuation command when a delay value register has been configured with a non-zero delay value by the bus master; and
delaying the trigger actuation signal until the counter has a value that matches the non-zero delay value.

3. The method of claim 2, wherein the delay value register is configured during the first transaction.

4. The method of claim 2, wherein the trigger actuation command is received during the first transaction.

5. The method of claim 2, further comprising:
restarting the counter after providing the trigger actuation signal when the delay value register maintains the non-zero delay value; and
providing an additional trigger actuation signal when the counter regains the value that matches the non-zero delay value.

6. The method of claim 1, further comprising:
receiving a cancellation indicator in a second transaction conducted over the serial bus before providing the trigger actuation signal; and
cancelling the trigger actuation signal in response to the cancellation indicator.

7. The method of claim 1, wherein the trigger actuation command is a broadcast command addressed to multiple devices coupled to the serial bus.

8. A data communication apparatus comprising:
an interface circuit adapted to couple the data communication apparatus to a serial bus and configured to:
receive trigger configuration information in a first transaction conducted over the serial bus; and
receive a trigger actuation command from a bus master coupled to the serial bus;
a clock source configured to provide a clock signal; and
a trigger handler configured to:
delay a trigger actuation signal for a delay duration defined by the trigger configuration information, wherein the trigger actuation signal is generated in response to the trigger actuation command; and
provide the trigger actuation signal after the delay duration has expired.

9. The data communication apparatus of claim 8, wherein the trigger handler comprises:
a counter configured to count clock pulses in the clock signal; and
a delay value register,
wherein the trigger handler is further configured to:
enable the counter to count after receiving the trigger actuation command when the delay value register has been configured with a non-zero delay value by the bus master; and
delay the trigger actuation signal until the counter has a value that matches the non-zero delay value.

10. The data communication apparatus of claim 9, wherein the delay value register is configured during the first transaction.

11. The data communication apparatus of claim 9, wherein the trigger actuation command is received during the first transaction.

12. The data communication apparatus of claim 9, wherein the trigger handler is further configured to:
restart the counter after providing the trigger actuation signal when the delay value register maintains the non-zero delay value; and
provide an additional trigger actuation signal when the counter regains the value that matches the non-zero delay value.

13. The data communication apparatus of claim 8, wherein:
the interface circuit is further configured to receive a cancellation indicator in a second transaction conducted over the serial bus before providing the trigger actuation signal; and
the trigger handler is further configured to cancel the trigger actuation signal in response to the cancellation indicator.

14. The data communication apparatus of claim 8, wherein the trigger actuation command is a broadcast command addressed to multiple devices coupled to the serial bus.

15. A method of data communications, comprising:
transmitting trigger configuration information in a first transaction conducted over a serial bus; and
transmitting a trigger actuation command to at least one slave device coupled to the serial bus,
wherein the trigger configuration information defines a delay duration used by the at least one slave device to delay one or more trigger actuation signals generated by the at least one slave device in response to the trigger actuation command.

16. The method of claim 15, wherein the trigger actuation command is transmitted in the first transaction.

17. The method of claim 15, wherein the trigger actuation command is transmitted in a second transaction after the first transaction.

18. The method of claim 15, wherein the trigger configuration information causes the at least one slave device to repetitively transmit a trigger actuation signal at a frequency defined by the delay duration.

19. The method of claim 15, further comprising:
transmitting a cancellation indicator in a third transaction conducted over the serial bus, wherein the cancellation indicator is configured to cause the at least one slave device to cancel the one or more trigger actuation signals.

20. The method of claim 15, wherein the trigger actuation command is a broadcast command addressed to multiple slave devices coupled to the serial bus.

21. A data communication apparatus comprising:
an interface circuit adapted to couple the data communication apparatus to a serial bus; and
a processor configured to:
transmit trigger configuration information in a first transaction conducted over the serial bus; and
transmit a trigger actuation command to at least one slave device coupled to the serial bus,
wherein the trigger configuration information defines a delay duration used by the at least one slave device to delay one or more trigger actuation signals generated by the at least one slave device in response to the trigger actuation command.

22. The data communication apparatus of claim 21, wherein the trigger actuation command is transmitted in the first transaction.

23. The data communication apparatus of claim 21, wherein the trigger actuation command is transmitted in a second transaction after the first transaction.

24. The data communication apparatus of claim 21, wherein the trigger configuration information causes the at least one slave device to repetitively transmit a trigger actuation signal at a frequency defined by the delay duration.

25. The data communication apparatus of claim 21, wherein the processor is further configured to:
transmit a cancellation indicator in a third transaction conducted over the serial bus, wherein the cancellation indicator is configured to cause the at least one slave device to cancel the one or more trigger actuation signals.

26. The data communication apparatus of claim 21, wherein the trigger actuation command is a broadcast command addressed to multiple slave devices coupled to the serial bus.
